(19) United States
(12) Patent Application Publication
(10) Pub. No.: US 2001/0023170 A1
(43) Pub. Date: Sep. 20, 2001

(54) Method and apparatus for conveying and separating of sausages or the like

(75) Inventors: Dieter Meier, Kirchlinteln (DE); Klaus Hiller, Dorverden (DE)

Correspondence Address: Kevin G. Rooney, WOOD, HERRON, EVANS, L.L.P., 2700 CAREW TOWER, 441 VINE STREET, CINCINNATI, OH, 45202, US

(73) Assignee: VEMAG Maschinenbau GmbH

(21) Appl. No.: 09/809,461

(22) Filed: Mar. 15, 2001

(30) Foreign Application Priority Data
Mar. 17, 2000 (DE) 100 13 036.4

(51) Int. Cl. A22C 11/00

(52) U.S. Cl. 452/49

(57) ABSTRACT

A method and an apparatus for conveying and individually separating sausages or other elongate foodstuff products, wherein the sausages are fed by a conveyor device (46) to a separating apparatus (8) with a separating tool. A sensor (64) which is responsive to the conveyor device (4) and which preferably cooperates with the drive motor of the conveyor device (4) or with the movable conveyor elements (36) of the conveyor device (6) produces a signal which represents a measurement for a current position of a movable conveyor element (36) of the conveyor device (6) and thus for a current position of one or more constriction or twist-off locations in the chain of sausages, and that the signal is fed to the separating apparatus (8) in order to control the drive motor (13) in such a way that the severing tool separates the sausages in the region of a twist-off location.

This application claims the priority of German Patent Application No. 10013036.4 filed Mar. 17, 2000, the disclosure of which is hereby fully incorporated by reference herein.

### FIELD OF THE INVENTION

The present invention concerns a method of conveying and individually separating sausages or other elongate foodstuff products.

### BACKGROUND OF THE INVENTION

A plurality of substantially uniformly portioned sausages typically form an interconnected chain and a respective constriction or twist-off location is arranged between the portioned sausages. The sausages are conveyed by means of a conveyor device having a drive motor, with conveyor elements which can be brought into contact with the sausages. The sausages are fed to a separating apparatus having a drive motor, with a severing tool for individually separating the portioned sausages, which is so controlled that the severing tool mutually separates intermittently adjacent sausages in the region of a twist-off location.

The invention further concerns an apparatus for conveying and individually separating sausages or other elongate foodstuff products which form an interconnected chain, wherein a respective constriction or twist-off location is arranged between substantially uniformly portioned sausages, comprising a conveyor device having a drive motor, with conveyor elements which can be brought into contact with the sausages, for conveying the chain of sausages, a separating apparatus which is connected downstream of the conveyor device in the conveying direction and which has a drive motor, with a severing tool for individually separating the portioned sausages, and a control device for controlling the separating apparatus in such a way that the severing tool is intermittently actuable such that adjacent sausages are severed in the region of a constriction or twist-off location.

As is known, an apparatus and a method of that kind are used, together with a filling machine, for introducing sausage meat into tubular natural or artificial skins. The sausage meat-filled skin is subdivided into portioned sausages of uniform length, by producing a twist-off location by virtue of rotating the filling tube about its longitudinal axis. The chain consisting of the portioned sausages is fed by the conveyor device to the separating apparatus which separates the individual sausages by means of a severing blade. The separate sausages are then subjected to further processing.

So that the drive motor of the separating apparatus is switched on at the correct time for movement of the blade, that is to say when a twist-off location of the chain of sausages is in the region of the blade, hitherto optical sensors have been used, which are responsive to the constriction or twist-off locations of the chain of sausages. Those sensors are arranged in the region of the blade and detect the contour of the sausages and thus a twist-off location and produce a signal for actuation of the blade.

A disadvantage with the known manner of detecting the twist-off locations on the sausages is that the detection procedure is affected by the contour of the sausages, and the diameter and/or the respective configuration of the sausage end portions in the region of the constriction or twist-off locations. The undesired consequence of this is that the cut for separating the sausages frequently occurs at the ‘wrong’ time and place and the cut surface is not centrally in the region of the twist-off location or is even outside the twist-off location in the region of a sausage which naturally then has to be sorted out.

A further important aspect in regard to manufacture in individually separating the sausages with the severing tool is the spacing of the severing tool from the upstream-disposed conveyor device. Experience has shown that, for a trouble-free mode of operation, the minimum possible spacing of the conveyor device from the blade is required in order to ensure that the sausages are not deflected by a radial force component which occurs in the cutting operation and are thus diverted out of their ‘normal’ straight path of movement. That gives rise to the disadvantage that a removal transportation apparatus which is usually connected downstream of the separating apparatus does not correctly engage the sausages and the removal transportation operation does not take place in a trouble-free manner or is even completely interrupted.

The object of the present invention is so to develop a method and an apparatus of the kind set forth in the opening part of this specification, while avoiding the disadvantages of the state of the art, that reliable and precise severing of the sausages at the constriction or twist-off locations is achieved and reliable, trouble-free transportation of the sausages is guaranteed.

### SUMMARY OF THE INVENTION

In a method of the kind stated in the opening part the invention attains that object in that a sensor which is responsive to the conveyor device and which preferably cooperates with the drive motor of the conveyor device or with the movable conveyor elements of the conveyor device produces a signal which represents a measurement for a current position of a movable conveyor element of the conveyor device and thus for a current position of one or more constriction or twist-off locations in the chain of sausages, and that the signal is fed to the separating apparatus in order to control the drive in such a way that the severing tool separates the sausages in the region of a twist-off location.

Furthermore, in an apparatus of the kind set forth in the opening part of this specification, the invention attains that object in that there is provided a sensor which is responsive to the conveyor device and which preferably cooperates with the drive motor of the conveyor device or with the movable conveyor elements of the conveyor device, for producing a signal which represents a measurement for a current position of a movable conveyor element of the conveyor device and thus for a current position of one or more twist-off locations in the chain of sausages, and that the sensor is coupled by means of a signal line to the separating apparatus and/or the control device, so that the drive of the separating apparatus can be intermittently switched such that the severing tool severs the sausages at a constriction or twist-off location.

The provision of the sensor which is responsive in accordance with the invention to the conveyor device means that detection of a constriction or a twist-off location is effected independently of the respective contour, which is subjected to random influences, of the sausages in the region of the sausage end portions and the diameter of the sausages, thus providing for substantially more reliable detection of the twist-off locations. That reliably prevents ‘incorrect cuts’ on the part of the separating apparatus outside the twist-off locations, that is to say in the sausages. In accordance with the invention the cut surfaces can even be produced substantially centrally in the twist-off locations. He ‘indirect’ detection of the twist-off locations by a sensor which is responsive to components of the conveyor device means that the severing tool can be actuated at the correct time to accurately meet the twist-off location.

Furthermore, in accordance with a further aspect, in a method of the kind set forth in the opening part of this specification, the invention attains the specified object in that immediately after leaving the conveyor device and prior to reaching the separating apparatus the portioned sausages are guided by means of a guide device having guide elements which can be brought into contact with the sausages.

In terms of the apparatus, the object is attained in that arranged in the direction of movement of the sausages between the conveyor device and the separating apparatus is a guide device for guiding the sausages and having guide elements which are arranged adjacent to the path of movement of the sausages and which can be brought into contact with the sausages.

The arrangement of the guide elements very substantially prevents deflection of the sausages, by virtue of the radial forces which are applied by the blade in the operation of cutting through the twist-off locations. That prevents the sausages from ‘hanging loosely’ and in that way the sausages can be reliably further transported and possibly reliably engaged by a discharge apparatus.

Particularly in the case of embodiments in which the conveyor device is in the form of a belt or chain conveyor with two circulating belts or chains on which dividing elements are respectively arranged in pairs in opposite relationship for constricting the sausages in the region of the constriction or twist-off location, it is particularly advantageous for the sensor to be arranged relative to the dividing elements in such a way that it delivers the signal when a dividing element passes into the region of the sensor. It will be appreciated that, by virtue of the projecting dividing elements, a larger spacing is necessary between the blade and the conveyor device, which without the guide device according to the invention could have the result that the sausages are deflected even at relatively low levels of radial force which are applied by the blade. That is reliably avoided in accordance with the invention.

In a preferred embodiment the guide elements are in the form of rotatably mounted guide rollers which oppose only a low level of frictional resistance to the sausages. If, in accordance with a preferred embodiment, the severing tool is in the form of a blade, it is proposed that there are provided two guide rollers which are arranged in parallel and mutually spaced relationship and whose axes of rotation are arranged substantially perpendicularly with respect to the direction of movement of the severing tool in the form of the blade, in the region of the intended cut surface, so that the deflection force which acts radially during the cutting operation is reliably counteracted.

It is moreover particularly advantageous if the guide rollers are drivable by means of a drive motor so that either there are no forces which are directed in opposite relationship to the movement of the sausages or even, in an advantageous manner, an additional pulling force can be applied to the sausages, insofar as the guide rollers are driven at a speed or rotation and with a torque required for that purpose.

It is also particularly preferred if the guide rollers are coupled to the drive motor of the conveyor device by means of a transmission. To provide for the simplest possible transmission of the torques involved, the guide rollers are coupled by means of a belt or by means of gears to a drive roller for driving a circulating conveyor chain of the conveyor device, thereby affording a simple structure, in particular when using a conveyor chain with projecting dividing elements for lengthwise portioning of the sausages.

In accordance with a further advantageous embodiment it is proposed that the blade of the separating apparatus is mounted rotatably and is drivable by means of an electric AC servomotor which is intermittently switched on by the signal from the sensor according to the invention.

For transporting away the separated sausages, a further conveyor device having two conveyor belts which circulate in mutually opposite relationship is preferably connected directly downstream of the sausage separating apparatus.

Easy accessibility to the separating apparatus for maintenance or cleaning is achieved by the conveyor apparatus being arranged on a lift table which is adjustable in respect of height.

### BRIEF DESCRIPTION OF THE DRAWINGS

Further advantageous developments of the invention are set forth in the appendant claims and are also apparent from the description hereinafter of preferred embodiments with reference to the accompanying drawings in which:

FIG. 1 is a side view of a filling machine with a downstream-connected apparatus according to the invention,

FIG. 2 is a plan view of the apparatus according to the invention,

FIG. 3 is a side view in partial section of a part of the apparatus according to the invention,

FIG. 4 is a further partial section, and

FIG. 5 is a plan view of a part of the apparatus according to the invention.

### DETAILED DESCRIPTION

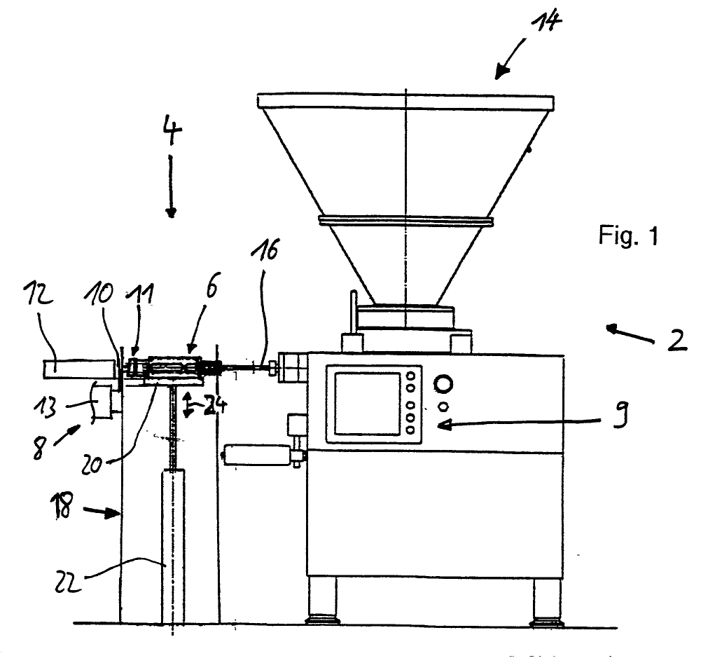

FIG. 1 is a diagrammatic side view showing a filling machine 2 and an adjacent apparatus 4 according to the invention for conveying and individually separating sausages. The apparatus 4 according to the invention has a conveyor device 6 for conveying and lengthwise portioning of the sausages and a guide device 11, as well as a separating apparatus 8 with a separating tool in the form of a blade 10 for cutting through the chain made up of sausages. Arranged adjacent to the separating apparatus 8 is a further conveyor device 1 2 which is referred to as the discharge apparatus and which provides for further transportation movement of the separated sausages.

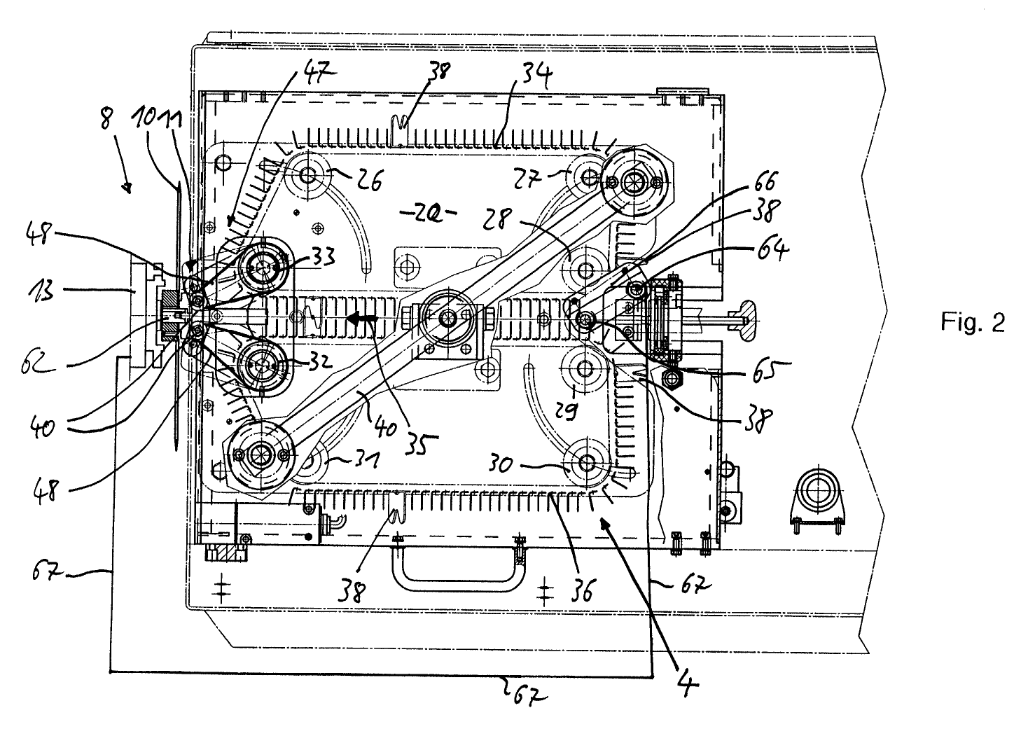

The filling machine 2 has a hopper 14 for receiving sausage meat, a filling pump (not shown) communicating with the hopper 14 and a filling tube 16 which is continuously or intermittently rotatable about its longitudinal axis and through which the sausage meat is conveyed. A control device (not shown) is provided for the control of all components of the filling machine and the apparatus 4. An operating panel 9 is provided on the filling machine 2. Further operating panels and operating elements (not shown) such as switches, displays and the like can be placed on a diagrammatically illustrated support frame structure 18. Arranged within the support frame structure 18 is a lift table 20 which can be moved up and down as indicated by the arrow 24 by means of a lift device 22. The lift device 22 (see FIG. 1) has a support arm 40 arranged beneath the lift table 20, as can be seen from FIG. 2. The separating apparatus 8 is mounted on the support frame structure 18. The further conveyor device 12 is mounted on a plate-like projection (not shown) of the support frame structure 18.

In operation the filling tube 1 6 is surrounded by a gathered-together artificial or natural skin which can be filled with sausage meat flowing out of the filling tube through an outlet opening. The filled skin then passes to the portioning and conveyor device 6 where it is divided into sausages which are of uniform length and which are thus portioned lengthwise and between which is disposed a respective constriction or twist-off location.

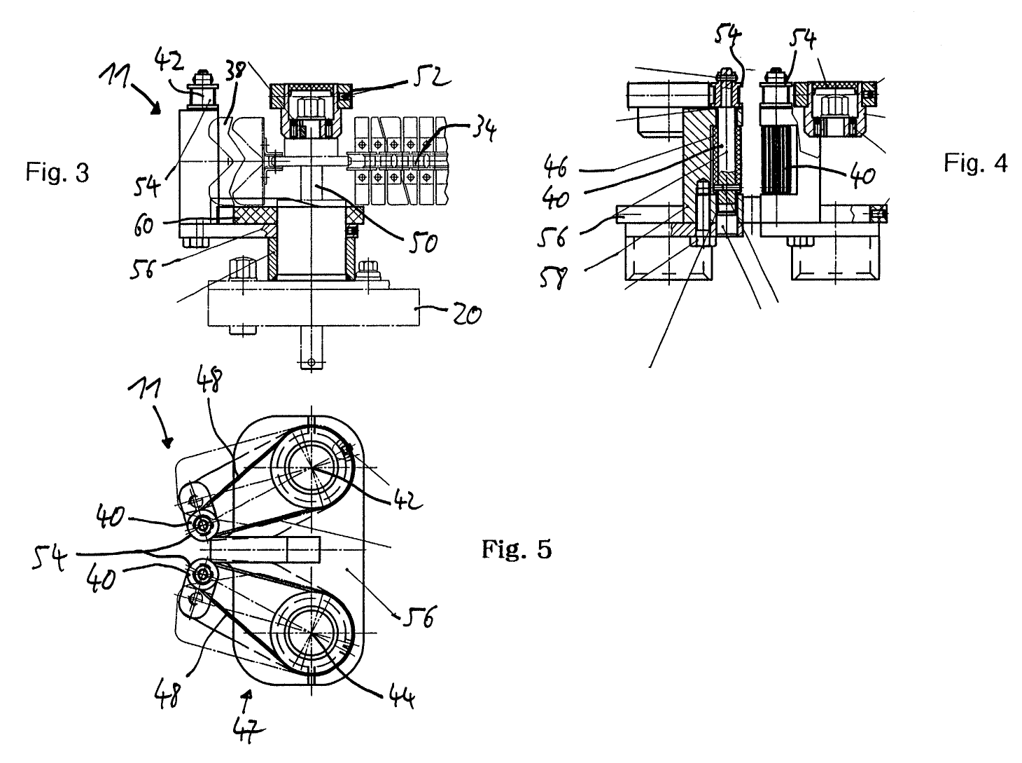

As FIGS. 2 and 3 show, the conveyor device 4 has two endless conveyor chains as conveyor elements 34, 36, wherein the conveyor chains are arranged symmetrically relative to each other and guided by means of a plurality of rollers 26, 27, 29, 30, 31, 32, 33. The rollers 32, 33 can be driven by means of a drive motor (not shown) so that the conveyor chains are moved synchronously in the direction indicated by the arrow 35. Secured to the conveyor elements 34, 36 at uniform spacings are a plurality of dividing elements 38 which are respectively disposed inclinedly in mutually opposite paired relationship and which by virtue of their plate-shaped configuration each with a V-shaped recess can engage into each other and is so doing clamp the filled skin in position. By virtue of the clamping action the skin is locally prevented from performing a rotary movement which has been applied by the filling machine by virtue of the rotating filling tube 16, and it is constricted, so that a constriction or twist-off location is produced. The production of a plurality of spaced twist-off locations results in the production of individual sausages 46 of substantially equal length, for the dividing elements 38 are arranged at equal spacings relative to each other. The lengthwise-portioned sausages forming a chain are transported in the direction indicated by the arrow 35 to the separating apparatus with a rotatable blade 10.

A guide device 11 is arranged between the conveyor arrangement and the separating apparatus 10 directly adjacent to the path of movement of the dividing elements 38. The guide device 11 has guide elements which are in the form of guide rollers 40 and which are arranged adjacent to the path of movement of the sausages and which laterally guide them after they have left the conveyor device 6 and are fed to the separating apparatus 8.

As can best be seen from FIGS. 3-5, the axes of rotation 42, 44 of the guide rollers are arranged parallel to each other. The guide rollers 40 which have an outer casing 46 of a soft plastic material are synchronously rotatable by means of the drive motor of the conveyor apparatus 4, with the interposition of a transmission 47 in the form of a toothed belt transmission, so that a pulling force can be applied in the direction of the arrow 35 to the sausages which are in contact with the guide rollers 40. The toothed belt transmission includes an endless toothed belt 48, a larger wheel 52 connected to a drive shaft coupled to the drive motor of the conveyor device 4, and a smaller wheel 54 which is fixed to the rollers above same. The guide rollers are mounted at the bottom to a projection 56 on the lift table 20 and at the top to a shaped carrier member 58 in sliding relationship. Arranged above the projection 56 is a further rigid guide plate 60 of plastic material such as PTFE on which the sausages slidingly rest.

The drive motor 13 of the separating apparatus 8, which is in the form of an AC servomotor, drives by means of its output shaft 62 (see FIG. 2) the blade 10 which has three cutting edges which project propeller-like and which with their outer end portion each sever a respective twist-off location which is being conveyed in the region of the blade 10. The drive motor 13 is switched off and on intermittently with the interposition of the control device (not shown), using an electrical output signal which is produced and delivered by a sensor 64 (FIG. 2) when the sensor 64 which is in the form of a magnetically inductive sensor detects a dividing element 38 of the guide and positioning arrangement. For that purpose the sensor 64 in the illustrated embodiment is fixed beneath the chains 34 to a holding member 66 arranged on the lift table 20.

By means of a transmission or signal line 67 (see FIG. 2), the electrical output signal of the sensor 64 is possibly firstly transmitted to the control device or however directly to the drive motor 13 of the separating apparatus 8 in order to drive the blade 10 intermittently at the moment or shortly before the moment at which a twist-off location of the chain of sausages passes into the region of the blade 10 so that the twist-off location can be severed centrally between two sausages, by the blade 10 meeting the twist-off location at a high peripheral speed in the region of the cut surface and thereby producing a clean cut through the twist-off location. By virtue of the spacings of the dividing elements 38 relative to each other and the geometrical conditions involved, in particular the spacing of the blade 10 from the guide device 4, it is possible, on the basis of the electrical output signal of the sensor 64, particularly with the interposition of the control device, to find exactly the time at which the drive motor 13 is temporarily switched on.

The sensor 64 is adjustable, that is to say it can be positioned and fixed three-dimensionally in different positions relative to the dividing elements 38 of the chains 34. In the situation where the sensor 64 is coupled by way of the line 47 directly to the drive motor 13 of the separating apparatus 8, the sensor can be positioned preferably along the direction of movement of the dividing elements 36, by displacement in a plane parallel to the lift table 20, in such a way that the drive motor 13 is switched on in such a fashion that the blade 10 severs the twist-off location substantially centrally. In the case where the signal from the sensor 64 is transmitted by way of the control device, suitable delay in transmission of the signal to the drive motor 1 3 can equally ensure that the blade 10 approximately centrally meets the twist-off location.

Displacement of the sensor 64 perpendicularly to the abovementioned plane makes it possible for the spacing relative to the dividing elements 38 to be varied and so set that a dividing element 38 is reliably detected.

Alternatively, a sensor according to the invention can be responsive to the drive motor of the conveyor device 4 or the movable conveyor elements in the form of the conveyor chains 34, and produce a signal which represents a measurement for a current position of the movable conveyor element in the form of the conveyor chain 34 and, by virtue of the arrangement of the dividing elements 38, also a measurement for the constriction or twist-off location of the chain of sausages. For example, it would be possible to arrange on the output shaft of the drive motor of the conveyor device 4 a rotary incremental sensor which produces a signal.

After the sausages have been severed at the twist-off location by the blade 10 they are individually guided to the discharge apparatus 12 (FIG. 1) and transported away therefrom for processing or packaging.

While the present invention has been illustrated by a description of a preferred embodiment and while this embodiment has been described in some detail, it is not the intention of the Applicants to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known. However, the invention itself should only be defined by the appended claims, wherein we claim:

1. A method of conveying and individually separating sausages or other elongate foodstuff products, wherein a plurality of substantially uniformly portioned sausages form an interconnected chain and a respective constriction or twist-off location is arranged between the portioned sausages, wherein the sausages are conveyed by means of a conveyor device (46) having a drive motor, with conveyor elements (36) which can be brought into contact with the sausages, and fed to a separating apparatus (8) having a drive motor (13), with a severing tool for individually separating the portioned sausages, which is so controlled that the severing tool mutually separates intermittently adjacent sausages in the region of a twist-off location, characterized in that a sensor (64) which is responsive to the conveyor device and which preferably cooperates with the drive motor of the conveyor device (4) or with the movable conveyor elements (36) of the conveyor device (6) produces a signal which represents a measurement for a current position of a movable conveyor element (36) of the conveyor device (6) and thus for a current position of one or more constriction or twist-off locations in the chain of sausages, and that the signal produced by the sensor (64) is fed to the separating apparatus (8) in order to control the drive motor (13) in such a way that the severing tool separates the sausages in the region of a twist-off location.

2. A method as set forth in claim 1 characterized in that the conveyor device (6) is in the form of a belt or chain conveyor having two circulating belts or chains (36) on which dividing elements (38) are respectively arranged in mutually oppositely disposed paired relationship for constricting the sausages in the region of the constriction or twist-off location and that the sensor (64) is so arranged relative to the dividing elements (38) that it delivers the signal when a dividing element (38) passes into the sensing region of the sensor (64).

3. A method as set forth in the classifying portion of claim 1 characterized in that immediately after leaving the conveyor device (6) and prior to reaching the separating apparatus (8) the portioned sausages are guided by means of a guide device (11) having guide elements which can be brought into contact with the sausages.

4. A method as set forth in claim 3 characterized in that the sausages are guided by two mutually oppositely disposed, rotatably mounted guide rollers (40).

5. A method as set forth in claim 4 characterized in that the guide rollers (40) are motor-driven.

6. A method as set forth in claim 5 characterized in that the guide rollers (40) are driven at such a speed of rotation that the sausages are acted upon by a pulling force acting in a direction towards the separating apparatus (8) for additionally conveying the sausages.

7. A method as set forth in claim 5 characterized in that the guide rollers (40) are driven by means of the drive motor of the conveyor device (6) with the interposition of a transmission (47).

8. Apparatus for conveying and individually separating sausages or other elongate foodstuff products which form an interconnected chain, wherein a respective constriction or twist-off location is arranged between substantially uniformly portioned sausages, in particular for carrying out a method as set forth in one of the preceding claims, comprising:
a conveyor device (6) having a drive motor, with conveyor elements (34, 36) which can be brought into contact with the sausages, for conveying the chain of sausages,
a separating apparatus which is connected downstream of the conveyor device (6) in the conveying direction (35) and which has a drive motor, with a severing tool for individually separating the portioned sausages, and
a control device for controlling the separating apparatus (8) in such a way that the severing tool is intermittently actuable such that adjacent sausages are severed in the region of a constriction or twist-off location,
characterized in that there is provided a sensor (64) which is responsive to the conveyor device and which preferably cooperates with the drive motor of the conveyor device (6) or with the movable conveyor elements (36, 38) of the conveyor device (6), for producing a signal which represents a measurement for a current position of a movable conveyor element (36, 38) of the conveyor device (6) and thus for a current position of one or more twist-off locations in the chain of sausages, and
the sensor (64) is coupled by means of a signal line to the separating apparatus (8) and/or the control device so that the drive of the separating apparatus (8) can be intermittently switched such that the severing tool severs the sausages at a constriction or twist-off location.

9. Apparatus as set forth in claim 8 characterized in that arranged in the direction of movement of the sausages between the conveyor device (6) and the separating apparatus (8) is a guide device (11) for guiding the sausages with guide elements (34, 36) which are arranged adjacent to the path of movement of the sausages and which can be brought into contact with the sausages.

10. Apparatus as set forth in claim 9 characterized in that the guide elements are in the form of rotatably mounted guide rollers (40).

11. Apparatus as set forth in claim 10 characterised in that there are provided two guide rollers (40) which are arranged in parallel and mutually spaced relationship and whose axes of rotation (42, 44) are arranged substantially perpendicularly with respect to the direction of movement of the severing tool which is in the form of a blade (10) in the region of the intended cut surface.

12. Apparatus as set forth in claim 10 characterised in that the guide rollers (40) are drivable by means of a drive motor.

13. Apparatus as set forth in claim 12 characterised in that the guide rollers are coupled by means of a transmission (47) to the drive motor of the conveyor device.

14. Apparatus as set forth in claim 13 characterised in that the guide rollers (40) are coupled by means of a belt (48) or by means of gears to a drive roller (52) for driving a circulating conveyor chain (34) of the conveyor device (6).

15. Apparatus as set forth in claim 11 characterized in that the blade (10) of the separating apparatus (8) is mounted rotatably and is drivable by means of an electric AC servomotor.

16. Apparatus as set forth in claim 8 characterized in that connected immediately downstream of the sausage separating apparatus (8) is a further conveyor device (12) having two oppositely disposed circulating conveyor belts.

17. Apparatus as set forth in claim 8 characterized in that the conveyor device (6) is arranged on a lift table (20) which is displaceable in respect of height.

18. Apparatus as set forth in claim 8 characterized in that the conveyor device (6) is arranged downstream of a filling machine (2) having a filling pump, a filling tube (16) rotatable about a longitudinal axis, and a filling hopper (14).
